(19) United States
(12) Patent Application Publication
(10) Pub. No.: US 2025/0111328 A1
(43) Pub. Date: Apr. 3, 2025

(54) SYSTEM AND METHODS FOR DELIVERY TO TRAVELING CUSTOMERS BASED ON NAVIGATION INFORMATION

(71) Applicant: Adeia Guides Inc., San Jose, CA (US)

(72) Inventors: Ning Xu, Irvine, CA (US); Serhad Doken, Bryn Mawr, PA (US); Aldis Sipolins, Somerville, MA (US); Dhananjay Lal, Englewood, CO (US); Tao Chen, Palo Alto, CA (US)

(21) Appl. No.: 18/374,167

(22) Filed: Sep. 28, 2023

(51) Int. Cl. G06Q 10/0835

(52) U.S. Cl. CPC G06Q 10/08355

(57) ABSTRACT

Systems and methods are described for enabling delivery of an order to a customer's vehicle travelling along a first navigational route. The customer inputs an order, and a plurality of candidate vendors and candidate delivery locations are determined. A target delivery location and target vendor are selected from among the plurality of candidate delivery locations and candidate vendors based on optimizing one or more predetermined criteria. The order is transmitted to the target vendor, and a confirmation is received. The target delivery location is then transmitted to the customer. The customer travels to the target delivery location to pick up the order.

### BACKGROUND

The present disclosure relates to methods and systems for enabling delivery of an order to vehicle at an optimized location based on the navigational route of the vehicle. In an embodiment, a delivery application receives an order from a customer riding in a vehicle, identifies a target vendor and a target delivery location based on the navigational route of the vehicle, and facilitates fulfillment of the order being delivered to the target delivery location. Some embodiments may relate to other features, functionalities, or fields.

### SUMMARY

Online and mobile ordering and delivery have become increasingly popular in recent years, with more and more customers relying on these services to receive products and food. The current delivery process, however, typically requires a designated stationary and fixed location for the delivery to take place. This may not be convenient for those who are traveling and do not have a stationary address. It also creates several challenges for customers who require deliveries while on the go. First, customers may desire a delivery on-the-go without having a set address for the delivery. Second, customers may desire a safe and reliable delivery service, to minimize the risks of theft or other harms.

In one approach, a company may attempt to use drone technology to deliver directly to customers, even to a car that is moving. However, the use of flying drones may be limited based on airspace restrictions, weather conditions, flight time of the drone, and weight/size restrictions for the goods being delivered. The current limited number of drones and drone deployment stations make intercepting a travelling vehicle with the desired goods nearly impossible.

Additionally, the drones themselves may be dangerous in certain circumstances, due to the use of fast spinning blades or other propulsion systems. These drawbacks make drone usage in some circumstances, such as for on-the-go delivery, potentially unreliable and unsafe.

In other approaches, when a customer places an order for food or products through an online delivery service, the order is typically sent to a nearby restaurant or retail store that has partnered with the delivery service. The restaurant or store then prepares the order and hands it off to a delivery driver who is assigned to transport the order to the customer address. The driver typically uses a GPS-enabled device and/or application to navigate to the customer's address. Once the driver arrives at the customer's address, they may either hand the order off directly to the customer or leave it at a designated drop-off location (e.g., a front desk, a vestibule, outside the front door, garage, etc.). However, this approach requires a fixed delivery location that is determined before the customer even places an order.

In light of the problems noted above, a solution is needed that allows travelers to request and receive deliveries without compromising safety or convenience. Embodiments of the present disclosure enable customers to order and receive deliveries (e.g., food or other goods) while they are travelling, with minimal disruption to their journey and without compromising safety. When a customer places an order, the delivery service system identifies a target vendor to fulfill the order, as well as a target delivery location. The target delivery location may be, e.g., a rest stop, a gas station, a restaurant, a package drop box, or other location on or close to the travelling route. The target vendor and delivery location pair may be an optimal pair identified from a plurality of candidate vendors and a plurality of candidate delivery locations using one or more criteria. The criteria may include the ability of each candidate vendor to fulfill the order and meet a desired delivery time frame (or delivery range along the customer's route), minimizing the customer's detour distance to the candidate delivery location, minimizing the delivery driver travel distance to the candidate delivery location, minimizing the wait time for the customer and/or delivery driver at the candidate delivery location, minimizing a travel distance for the delivery driver from the candidate vendor to the candidate delivery location, considering the suitability of the delivery location with respect to the ordered item (e.g., picking up an item in a low traffic area vs. a high traffic area), considering a safety of the candidate delivery location (e.g., high crime rate vs. low crime rate), and many more. One or more algorithms and/or cost functions may be used to identify the optimal delivery location and vendor to fulfill any given order. Once the target vendor and delivery location are identified and/or confirmed by the customer, the vendor prepares the order, and a delivery vehicle brings the prepared order to the target delivery location. The target delivery location and estimated arrival time are also transmitted to the customer, and the customer may then travel to and/or detour from her existing route to the target delivery location and pick up her order.

In some examples, the customer may input her order via text, or via speech analyzed using NLP. The input order may be as minimal as a desired product only (i.e., with no specified vendor or delivery time), or may include additional information such as a desired vendor, desired delivery location, desired delivery time frame and/or range for delivery along the customer's route, and more.

In examples where the customer is travelling along a predetermined navigational route, the target vendor and/or target delivery location may be selected based on that route. If the customer changes her route during transit, the target vendor and/or target delivery location may also be dynamically changed and optimized based on the updated navigational route. Additionally, if the customer inputs a desired delivery time or timeframe (e.g., as soon as possible), the delivery service may use the customer's navigational route to identify the location the customer is expected to be at the desired time, and may use this expected location to determine the optimal target vendor and target delivery location. Additionally, in some examples the delivery service may use the customer's user profile to determine one or more criteria and to determine the target vendor and delivery location.

In some examples, the delivery service may select the target vendor from a plurality of possible vendors based on the respective ability of each vendor to fulfill the order in time, to deliver the order to the target delivery location in time, and to minimize costs. The delivery service may also prioritize certain criteria used to determine the target vendor and target delivery location over others, such as to minimize the customer detour, minimize the customer wait time at the target delivery location, provide delivery as soon as possible, etc. Additionally, in some examples, the customer may have an option to pay more to prioritize certain criteria over others, such as if an express delivery is desired.

In some examples, certain functions described in this disclosure may operate in connection with a rideshare application. The customer may input a destination into an application (e.g., a delivery service application). Before and/or during travel to that destination, the customer may also place an order for food or other goods into the application, along with a desired delivery time or time range. The delivery service application may then identify a target vendor and target delivery location based on the known route of the customer (and/or the desired delivery time or time range), which may be along the route or at the destination. The customer may then receive her order at the target delivery location, which may be at the customers staring location, somewhere along the route, or at the customer's destination. In some examples, the delivery service application may update the route to add a stop at the target vendor location, or at the identified target delivery location. Further, in some examples, the rideshare driver may be a part of the delivery service as well.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an example scenario in which a first vehicle requests delivery of an order, and a delivery application determines a target vendor and target delivery location for delivery of the order based on the first vehicle's navigational route, in accordance with some examples of the disclosure;

FIG. 2 illustrates an example sequence diagram of example steps for delivering an order to a first vehicle based on the navigational route of the first vehicle, in accordance with some examples of the disclosure;

FIG. 3 illustrates an example scenario showing how a target vendor and a target delivery location can be determined based on a target range within the navigational route of the first vehicle, in accordance with some examples of the disclosure;

FIG. 4 illustrates an example scenario showing how a target vendor and a target delivery location can be determined based on minimizing a detour for the first vehicle, in accordance with some examples of the disclosure;

FIG. 5 illustrates an example sequence diagram of example steps for delivering an order to a customer in a rideshare context, in accordance with some examples of the disclosure;

FIGS. 6-7 illustrate example devices, systems, servers, and related hardware for enabling delivery of an order to a first vehicle, in accordance with some examples of the disclosure.

### DETAILED DESCRIPTION

As noted above, there are problems with delivering food and other goods to a customer who does not have a fixed location, such as a customer who is in transit to a destination. With these problems in mind, example methods and systems described herein propose techniques to enable customers to receive deliveries while on the road at optimal locations and times based on the customers' navigational routes or itineraries. When a customer is travelling according to a given navigational route or instructions, he/she can place an order for food or products to be delivered. The order will be analyzed using technologies such as automatic speech recognition (ASR) and natural language processing (NLP) to identify the necessary information for an order, such as the items and quantity, possible brand/vendor name, the delivery time frame or location range, etc. In an example, a customer may use voice commands when he/she is driving to input an order, and may also provide a target time frame for delivery. The target time frame may be set to an earliest possible time if none is provided by the customer. The order information, together with the navigation information, may then be sent to the delivery service. The delivery service may then identify candidate delivery locations along the customer's route within a target range (i.e., specified by the customer or inferred from the customer's inputs). For each candidate delivery location, the service may also identify restaurants, stores, or vendors that can fulfill the customer's order and deliver to the candidate delivery location in time, and assigns the order to a vendor that, when paired with the candidate delivery location, can optimize the time and cost of the delivery. The restaurant, store, or vendor then prepares the order and delivers it to the designated delivery location. The customer is also notified of the designated delivery location (and/or the identity of the target vendor, and the ETA), and the navigation information that the customer is following while travelling is updated with a detour to lead the customer towards the delivery location. The customer then travels along the detour to the delivery location, picks up the order, and then continues on to his/her original destination.

In this disclosure, examples may refer to a vehicle taking an action (e.g., the first vehicle 110 transmits the order to the delivery application server 120). It should be appreciated that the description of a vehicle taking the action may additionally or alternatively include a system or device associated with the vehicle performing the action. For example, an application corresponding to the vehicle, such as a navigation application or delivery application running on the vehicle or on a smartphone of a user in the vehicle, may perform the functions described herein instead of or in addition to the vehicle itself. For simplicity, the examples described herein may simply refer to “the vehicle” performing one or more functions.

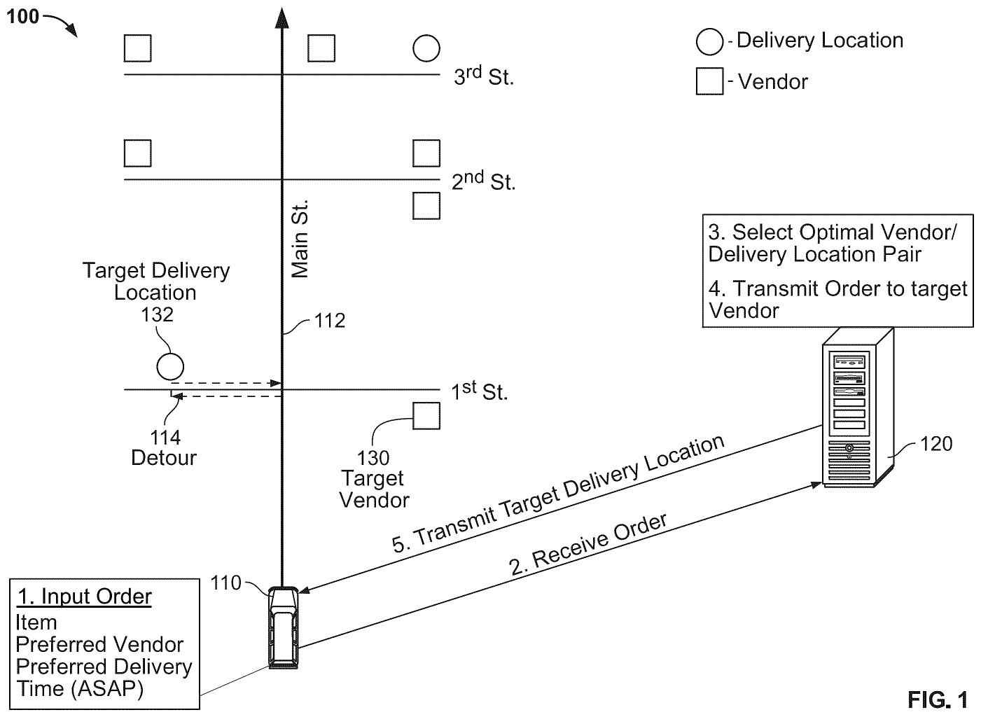

FIG. 1 illustrates an example scenario 100. As shown in FIG. 1, the vehicle 110 may be travelling along a navigational route 112. The user of vehicle 110 may input an order for food or goods. The input may be made via a delivery application running on the vehicle 110, via a user device (e.g., smart phone) of customer travelling in vehicle 110, or from a third party on behalf of a customer in the vehicle 110 (e.g., a friend inputting an order on behalf of the user of vehicle 110). Once the order is input, the vehicle 110 transmits the order to the delivery application server 120, along with the navigational route 112.

Upon receiving the order and the navigational route 112, the delivery application server 120 may identify a plurality of candidate vendors that might fulfill the order. The delivery application server 120 may also identify a plurality of candidate delivery locations that might be used to deliver the order to the vehicle 110 at some point along or nearby the navigational route 112. The delivery application server 120 selects a target vendor 130 and a target delivery location 132 using one or more algorithms, cost functions, or other optimization techniques (discussed in further detail below).

The delivery application server 120 then sends the order, target delivery location 132, expected delivery time, and other relevant information to the target vendor 130. The target vendor 130 then confirms the order (e.g., confirms that it can fulfill the order in the requisite time) and confirms the target delivery location 132 (e.g., confirms that it can deliver to the target delivery location 132 in the requisite time).

The delivery application server 120 also transmits the target delivery location 132 to the vehicle 110, and/or transmits updated navigational instructions including a detour 114 to the vehicle 110. The delivery application server 120 may also transmit the vendor identity or other vendor information to the customer, as well as the ETA and various other information. The vehicle 110 then follows the detour 114 and/or the updated navigational instructions to the target delivery location 132. The delivery driver (e.g., car, bike, walker, drone, etc.) brings the fulfilled order from the target vendor 130 to the target delivery location 132. The vehicle 110 then picks up the fulfilled order at the target delivery location 132, and the vehicle 110 follows the detour 114 back to the navigational route 112, to continue on to the vehicle 110's original destination.

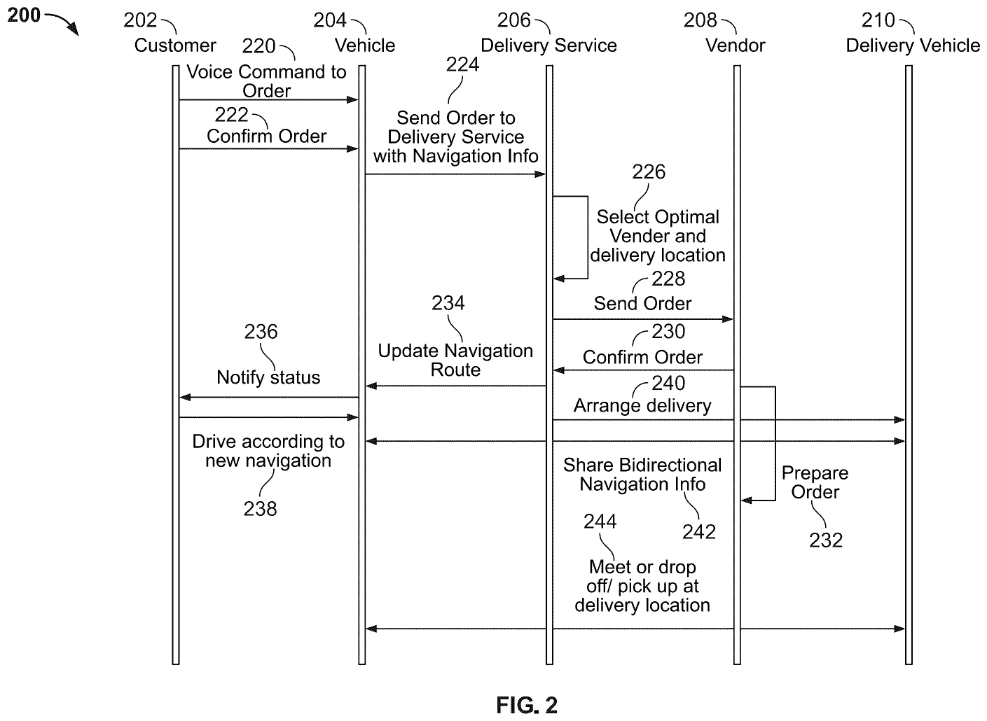

FIG. 2 illustrates a sequence diagram 200 of example steps for delivering an order to a customer 202 in a first vehicle 204 based on the navigational route of the first vehicle 204, in accordance with some examples of the disclosure. The steps of sequence diagram 200 operate in connection with a system comprising a customer 202, a first vehicle 204, a delivery service (or delivery application) 206, a vendor 208, and a delivery vehicle 210. The sequence shown in FIG. 2 corresponds to a scenario in which the customer 202 inputs an order to the first vehicle 204. The first vehicle 204 is communicatively coupled to the delivery service 206. It should be appreciated that this is just one example setup. In other examples, the customer 202 may input her order via her smartphone or other computing device, which may or may not be communicatively coupled to the first vehicle 204. In these other cases, the customer's smartphone may communicate with the delivery service 206 via the first vehicle 204, or may communicated directly with the delivery service 206. Other setups are possible as well.

The customer 202 may be a driver of the first vehicle 204, a passenger of the first vehicle 204, or may be a third party (not present in the first vehicle 204) making an order on behalf of an occupant of the first vehicle 204. For purposes of clarity, each of these people may be referred to as the customer 202.

The first vehicle 204 may be associated with a first navigational route. The customer 202 may input a destination to the vehicle and/or a navigation application (e.g., Google Maps or Apple Maps). The first vehicle 204 and/or the navigation application or navigation server may store various information about the first navigational route, including the destination, turn by turn instructions, expected arrival time at the destination, expected arrival time at each segment of the route, predicted duration of travel along each segment of the route, etc.

The delivery service 206 may be an application running on a server or set of servers. The delivery service 206 may be configured to coordinate delivery of the order to the first vehicle 204. Various functions and actions of the delivery service 206 are discussed in further detail below.

The vendor 208 in FIG. 2 corresponds to the target vendor identified from a plurality of candidate vendors by the delivery service 206. The target vendor 208 may be configured to fulfill the customer's order (e.g., prepare the food, package the requested goods, etc.).

The delivery vehicle 210 may be configured to deliver the fulfilled order from the vendor 208 to the target delivery location identified by the delivery service 206. The delivery vehicle 210 may be affiliated with the vendor 208 itself (e.g., a delivery driver for the vendor itself), may be affiliated with the delivery service 206 (e.g., a separate delivery driver from the vendor), and/or may be a third-party delivery driver affiliated with another company (e.g., a driver for UberEATS, etc.). The delivery driver 206 may refer to a variety of modes of transportation, including a car or bicycle. The delivery driver 206 may also refer to a person walking, a drone delivery system, or an automated system (e.g., an autonomous vehicle acting as a delivery vehicle sent from the vendor to the target delivery location).

Referring now to the steps of the sequence diagram 200, the sequence begins with the customer 202 inputting an order to the vehicle 204 at step 220. The customer may input the order using a voice command, a text input, or any other suitable user input. The order may include various information, such as (a) a desired product (e.g., a phone charger), (b) a desired food item (e.g., a burger), (c) a desired vendor (e.g., a convenience store, a burger store, etc.), (d) a desired delivery location or area (e.g., a location spoken by the user, drawn on a map displayed on a vehicle user interface, selected from a predetermined set of delivery locations/area, etc.), (e) a desired delivery location type (e.g., a gas station, a drop box/lock box such as an Amazon Locker, etc.), (f) a desired delivery range along the vehicle's route (e.g., an input location or distance such as “deliver in 10 miles,” an input range drawn on a map, etc.), (g) a desired delivery time (e.g., input via speech, text, selected from pre-determined options, or converted from an input location based on the expected time of arrival at the input location based on the vehicle's navigational route), (h) a desired delivery time range (e.g., a time range converted from an input location range based on the expected location of the vehicle using navigational route), and (i) a desired delivery service (e.g., UberEATS, etc.).

In some examples, the order and various other information may be input via an application running on the vehicle 204, via a user interface of the vehicle 204. In other examples, the order and various other information may be input via a smartphone or other device associated with the vehicle 204. The order and other information may be input prior to the vehicle 204 moving along the navigational route or during travel along the navigational route. In some examples, the customer 202 may change the order after the initial input to specify a different location or time for delivery. The delivery service 206 may then run an updated analysis (described in further detail below).

At step 222, the vehicle 204 and customer 202 perform a process to confirm the order. This may include the vehicle 204 presenting the order to the customer 202 via a vehicle user interface, including an audio output and/or visual output of the order. The vehicle 204 may prompt the customer 202 for confirmation of the order, such as requesting a tap on a display screen or verbal confirmation (e.g., “speak ‘yes’ to confirm your order”). In some examples, the vehicle 204 may request additional information. For instance, a customer 202 may order “an In-and-Out meal #1 to be delivered to me in 1 hour” or “a car charger for iPhone from Amazon by 3 pm.” In the latter case, the vehicle 204 may prompt the customer 202 to clarify the product of interest if necessary, leveraging a voice assistant and/or NLP to understand and resolve ambiguity. In some cases, the order may be incomplete in some way. The vehicle 204 may request additional information from the customer such as a preferred delivery time if none was input. In other cases, the vehicle 204 may automatically include a default for certain information, such as making the preferred delivery time “as soon as possible” unless otherwise specified.

At step 224, the vehicle 204 transmits the order to the delivery service 206, along with various other information including the navigational information associated with the vehicle 204. This may include transmitting the order and any other user inputs (e.g., preferred vendor, preferred delivery time, etc.). Any missing information that is needed to make determinations about the optimal vendor and delivery location may be determined based on default values (e.g., ASAP delivery when none is specified). In some examples, the customer 202 may have an associated user profile, which may specify certain preferences such as a preferred vendor or other default settings. In some examples, the delivery service 206 may retrieve the navigational information associated with the vehicle 204 from another source rather than the vehicle 204 itself. For example, the delivery service 206 may receive the navigational information from a navigation server that provides data to the vehicle 204 for navigation.

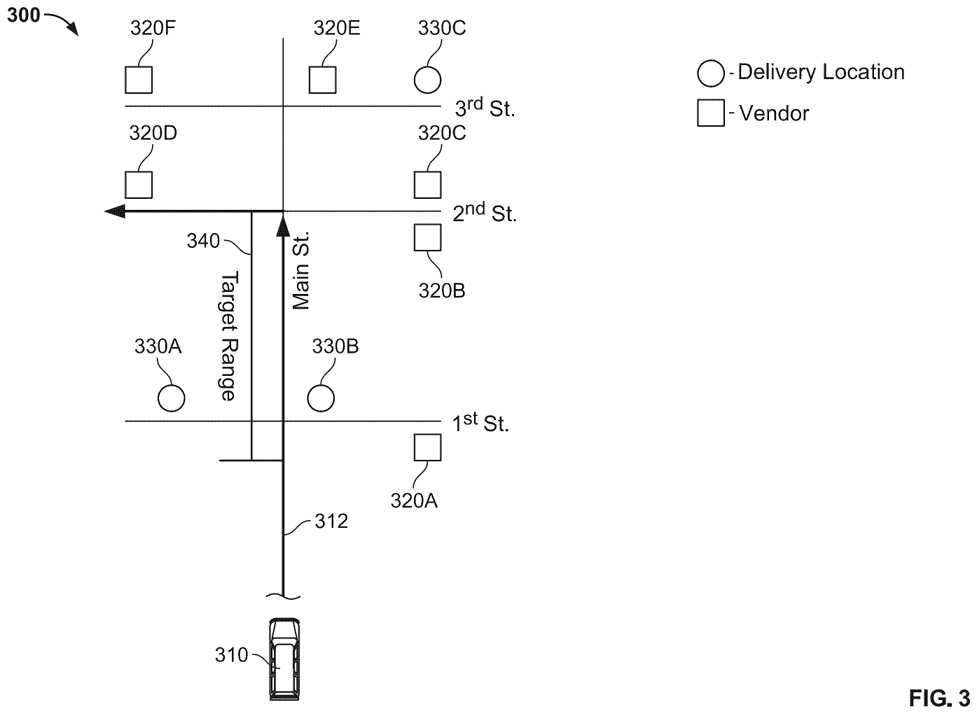

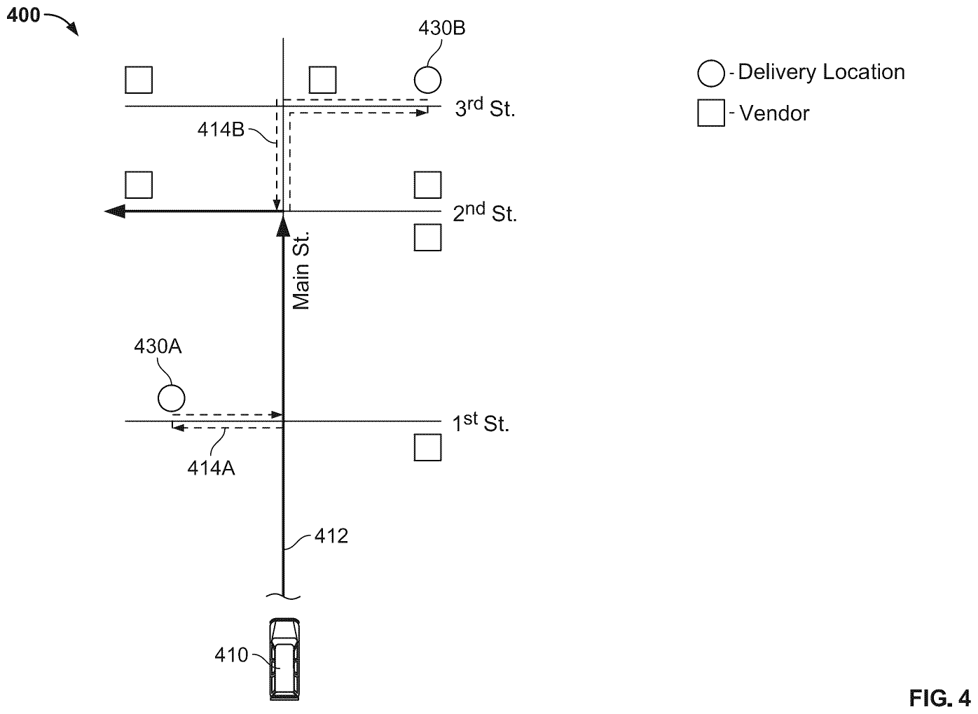

At step 226, the delivery service 206 determines or selects a target vendor and a target delivery location (which may also be called the selected vendor, selected delivery location, optimal vendor, and/or optimal delivery location). There may be a plurality of candidate vendors that may be able to fulfill the order, and a plurality of candidate delivery locations at which the order may be delivered to the customer 202. The process of determining the target vendor and target delivery location is described in further detail with respect to FIGS. 3 and 4.

At step 228, the delivery service 206 transmits the customer's order to the identified target vendor 208. The delivery service 206 may transmit additional information as well, such as the target delivery location, delivery time frame, and more.

At step 230, the target vendor 208 confirms the order. The target vendor 208 may evaluate the order, target delivery location, delivery time frame, and more in order to determine whether it can actually fulfill the order given the identified constraints. If the target vendor 208 is unable to fulfill the order in the required time, the target vendor 208 may instead decline the order. In this case, the delivery service 206 may identify a next best target vendor (or second target vendor) and/or target delivery location. The delivery service 206 may then send the order to the second target vendor, which may then confirm the order. If the second target vendor also declines the order, the delivery service 206 may run down the list of candidate vendors and/or candidate delivery locations until one of the vendors confirms the order. In some examples, the delivery service may transmit the order to multiple candidate vendors and may allow the candidate vendors to bid on the order. The delivery service 206 may then select the candidate vendor with the best bid, (e.g., the highest bid, most suitable bit, or other “best” bid based on one or more vendor criteria which may be set by the customer and/or delivery service).

At step 232, the target vendor 208 prepares the order. This may include the target vendor 208 preparing food, retrieving goods, packaging the food or goods, etc. At step 234, the delivery service 206 provides the target delivery location to the vehicle 204. This may include transmitting updated navigational instructions to the vehicle 204, transmitting a detour to the vehicle 204, instructing a navigational server to update the navigational information for the vehicle 204 to bring the vehicle 204 to the target delivery location, and more. In some examples, the delivery service 206 may provide only the target delivery location to the vehicle 204. In other examples, the delivery service 206 may provide a detour, and/or a second navigational route or recalculated navigational route that takes vehicle 204 from its current navigational route along a detour to the target delivery location, and then back to the first navigational route so the vehicle 204 can continue to its original destination. In some examples, the delivery service 206 may operate in connection with a navigation server to provide an updated navigational route or updated instructions to the vehicle 204.

At step 236, the vehicle 204 may provide an indication of the status of the order to the customer 202. For example, the vehicle 204 may present an indication that the order has been received by the target vendor and/or has been confirmed and is being prepared. At step 238, the customer 202 may drive the vehicle 204 according to the updated navigational instructions received at step 234. The customer 202 may drive the vehicle 204 to the identified target delivery location.

At step 240, the delivery service 206 may arrange the delivery of the order to the target delivery location with the delivery vehicle 210. In the illustrated example, the delivery vehicle 210 is not affiliated with the vendor 208. In other examples, the delivery vehicle 210 may be affiliated with the delivery service 206 or may be affiliated with a third-party delivery entity. The delivery service 206 may coordinate with the delivery vehicle 210 to make the delivery of the order from the vendor 208 to the target delivery location. This can include sending a request to the delivery vehicle 210, and/or sending a request to the third-party delivery service. In some examples, this may include transmitting the order, the target delivery location, the delivery time frame, various information about the customer 202 and/or vehicle 204 (e.g., customer's identity, navigational route, expected arrival time at the delivery location, etc.) to facilitate completion of the delivery. In some examples, the vendor 208 may be responsible for the delivery of the order. In this case, the vendor 208 may coordinate with the delivery vehicle 210 to complete the delivery. In some examples, the delivery vehicle 210 may be an autonomous vehicle that may make waiting for handover a less costly option than dropping off. In some examples, a handover mechanism can be developed, such as providing the customer with a one-time use passcode that can be used to open the trunk of the autonomous car to retrieve the order.

At step 242, the vehicle 204 and the delivery vehicle 210 may share navigational information with each other. This may include providing real-time updates on the status of the order preparation and delivery, allowing the customer to track the progress of their order and receive notifications on the estimated time of arrival of the order at the target delivery location. In some examples, sharing navigational information may include providing the location of the delivery driver to the customer and vice versa. Sharing the locations of the vehicle 204 and the delivery driver 210 may help to ensure that the customer 202 and delivery driver 210 are fully informed and can make necessary adjustments to their travel plans if needed.

In some examples, the delivery service 206 may calculate a difference in time between when the two parties are expected to arrive at the target delivery location. This information may be useful particularly if the order is going to be a handover instead of dropping off by the delivery person and picking up by the customer. The vendor 208 and/or delivery service 206 may also provide updates to the vehicle 204 and/or the delivery vehicle 210 about the status of the order. In some examples, the order information will be shown on the customer's navigation map, allowing the customer 202 to view the location of her order as it is delivered to the target delivery location. Before the delivery starts, the vehicle 204 may display where the order is (e.g., at the target vendor), and after the delivery vehicle 210 begins brining the order to the target delivery location, the vehicle 204 may display the real-time location of the order.

At step 244, the vehicle 204 may arrive at the target delivery location and the customer 202 may pick up the order from the delivery location. Where the delivery is a hand-off, the delivery driver 210 and the vehicle 204 may meet for the handoff. Alternatively, where the target delivery location is a drop box (e.g., Amazon Locker) or other such location, the delivery driver may place the order at the target delivery location and then leave. The customer 202 may then arrive at the target delivery location to pick up the order, without making any contact with the delivery driver.

FIGS. 3 and 4 illustrate examples that show how the delivery service may identify a target vendor and target delivery location from among a plurality of candidate vendors and candidate delivery locations. In one example, after the delivery service receives an order, it may (1) determine a target range along the customer's route for the delivery to occur, (2) identify a plurality of candidate delivery locations based on the target range, (3) identify a plurality of candidate vendors that can prepare and deliver the order to the candidate delivery location within the specified time frame (i.e., with delivery by the vendor itself or via a third-party delivery service), and (4) after identifying all the possible candidate vendors and candidate delivery locations that are able to fulfill the order within the specified time range, the delivery service will evaluate each pair based on various input criteria to find the optimal vendor and delivery location. Each of steps (1)-(4) is discussed in further detail below.

After receiving the order from the customer, the delivery service may (1) determine a target range along the customer's route for the delivery to occur. This can include analyzing the received order to determine whether the customer has input a desired target range where he/she would like the delivery to occur (e.g., “deliver in 10 miles”). The delivery service may analyze the order in connection with the navigational route associated with the vehicle to determine a segment of the navigational route that aligns with the specified delivery range. FIG. 3 illustrates this concept.

FIG. 3 illustrates a vehicle 310 travelling along a first navigational route 312. When the customer inputs her order, the customer may specify a delivery range (e.g., “deliver when I arrive at Town”). The vehicle and/or delivery service may interpret the input “when I arrive at Town” as corresponding to segment 340 of the first navigational route 312. The delivery service may then identify segment 340 as the target range along the customer's route for delivery of the order.

In some examples, such as the one noted above, the customer may specify a target range directly by making a direct input. In other examples, the target range may be inferred or identified based on a different input. For example, the customer may specify a delivery time, time frame, or time range (used interchangeably) which may be converted to a target range based on the vehicle's navigational route. If the customer of vehicle 310 instead made an input of “deliver to me in 30 min,” the vehicle and/or delivery service may convert that to a target range along the navigational route 312 based on the expected location of the vehicle in 30 minutes if the vehicle adheres to the navigational instructions. In that case, the target range may be identified as segment 340 if the vehicle 310 is expected to be located at segment 340 in 30 min from when the customer made the order.

In another example, if the customer makes an input to have something delivered by 12:00 pm, the target time frame may be set to a range of 11:30 am-12:00 pm. This length may be changed by the user in his/her profile. This target time frame can then be converted to a target range along the navigational route by determining where along the route the customer is expected to be during that target time frame.

In some examples, rather than specifying a target range or target time frame, the customer may specific a delivery location or delivery area. The customer may input the desired delivery location or area via speech, text, may draw an area on a map (e.g., on a vehicle display), and/or may select a desired delivery location or area from a list or display of predetermined delivery locations or areas. The customer may also or alternatively specify a desired delivery location type (e.g., gas station, drop box/lock box such as Amazon Locker, etc.). This desired delivery location type may be set in the user profile. Various other input from the user may also be used to identify a target range where the customer would like the delivery to occur.

Given the target range, the delivery service may then (2) identify a plurality of candidate delivery locations based on the target range. This may include identifying all possible delivery locations that are within a certain radius of the identified target range, are within a certain travel distance along existing roads from the identified target range, and/or are within a certain travel time from the identified target range (e.g., based on current traffic conditions). In FIG. 3, these are shown as candidate delivery locations 330A, 330B, and 330C. The delivery service may rank the plurality of candidate delivery locations based on one or more criteria, such as the additional distance required for the customer to reach the respective delivery location from the first navigational route. In the illustrated example, candidate delivery location 330B may be ranked as the best candidate delivery location since it is located the shortest distance from the first navigational route 312 and/or the target range 340. Candidate delivery locations 330A and 330C may be lower ranked, because they are each located a greater distance from the first navigational route 312 and/or the target range 340. In some examples, the candidate delivery locations may be ranked based on their location or distance relative to the first navigational route 312 and/or the target range 340. In some examples, the target delivery locations may be ranked based on the expected travel time or travel distance from the navigational route 312 and/or the target range 340 to the respective candidate delivery location. In still other examples, the candidate delivery locations may be ranked based on one or more other factors, such as a preference for a certain type of delivery location specified by the customer (e.g., in the order or in a user profile), based on local traffic conditions near the first navigational route 312 and/or target range 340, based on the number of candidate vendors within an area of the respective candidate delivery location, and more.

FIG. 4 illustrates a first candidate delivery location 430A and a second candidate delivery location 430B. FIG. 4 also illustrates a first detour 414A corresponding to the first candidate delivery location 430A and a second detour 414B corresponding to the second candidate delivery location 430B. Candidate delivery location 430A is closer to the first navigational route 412 than the second candidate delivery location 430B (i.e., the first detour 414A is shorter than the second detour 414B), so the first candidate delivery location 430A may be higher ranked.

After or while determining the plurality of candidate delivery locations, the delivery service may (3) identify a plurality of candidate vendors for each of the plurality of candidate delivery locations that can prepare and deliver the order to the respective candidate delivery location within a specified time frame. This time frame may be based on the order (e.g., “deliver to me as 12:00 pm”). The delivery service may identify all possible candidate vendors located within a certain radius of the respective candidate delivery locations, identify all candidate vendors that are located within a certain travel distance along existing roads from the respective candidate delivery locations, and/or identify all candidate vendors that are located within a certain travel time from the respective candidate delivery locations (e.g., based on current traffic conditions). In FIG. 3, these are shown as candidate vendors 320A, 320B, 320C, 320D, 320E, and 320F. The delivery service may rank the candidate vendors to find a best candidate vendor for one or more of the candidate delivery locations. The delivery service may rank the candidate vendors based on one or more criteria, such as (a) a distance from the candidate vendor to the candidate delivery location, (b) a drive time from the candidate vendor to the candidate delivery location, (c) an availability/location of delivery personnel associated with the candidate vendor, (d) an availability/location of delivery personnel associated with a delivery service (or a third party delivery service), (e) an availability of autonomous delivery vehicles, and more. The delivery service may rank the candidate vendors with respect to each other, and/or with respect to each candidate delivery location. That is, the delivery service may determine a best candidate vendor for one or more of the candidate delivery locations, and the best candidate vendor for a first candidate delivery location may be different from the best candidate vendor for a second candidate delivery location. The delivery service may also identify pairs of candidate delivery locations and candidate vendors using one or more algorithms or optimization functions to determine the best candidate delivery location/candidate vendor pair for a given order.

After identifying the candidate delivery location/candidate vendor pairs, the delivery service may evaluate each pair based on various input criteria. The input criteria may include, for example, (a) time (e.g., identify an estimated delivery time for each candidate delivery location and candidate vendor pair and ranking the pairs based on the estimated delivery times), (b) delivery cost (e.g., identify the delivery cost for each candidate delivery location and candidate vendor pair, and ranking the pairs based on the respective delivery costs), (c) minimizing overall cost of resources (e.g., identify the resource cost, such as fuel/energy usage, for each candidate delivery location and candidate vendor pair, and ranking the pairs based on the resource costs), (d) feasibility (e.g., consider only candidate delivery location and candidate vendor pairs that are able to result in a delivery of the order to the customer within the customer's specified constraints such as delivery location and delivery time), (e) minimizing customer wait time at the delivery location (e.g., estimating the customer wait time for each candidate delivery location and candidate vendor pair, and ranking the pairs based on the estimated customer wait times), (f) minimizing delivery driver wait time at the delivery location (e.g., estimating the delivery driver wait time for each candidate delivery location and candidate vendor pair, and ranking the pairs based on the estimated delivery driver wait times), (g) vendor specific factors (e.g., ranking the candidate delivery location and candidate vendor pairs based on vendor specific factors such as the time required by each vendor to fulfill the order, the staffing at each vendor, the number of available delivery drivers, etc.), (h) minimizing travel distance for the delivery driver (e.g., ranking the candidate delivery location and candidate vendor pairs based on the travel distance required for the delivery driver), (i) considering other orders being fulfilled by a delivery driver or delivery service for a given vendor (e.g., the delivery service may rank a candidate delivery location and candidate vendor pair higher if it enables a single delivery driver to deliver two or more orders without travelling back to the vendor), (j) minimizing the detour distance for the customer (e.g., ranking candidate delivery location and candidate vendor pairs based on the required detour for the customer), and (k) considering expected traffic conditions (e.g., ranking candidate delivery location and candidate vendor pairs based on traffic conditions which may affect the timing of when a delivery driver is able to arrive at the candidate delivery location, whether a route will be blocked or slow for a delivery driver travelling to the candidate delivery location from one vendor vs another vendor, etc.).

The delivery service may consider the criteria noted above, as well as others, and may select the candidate delivery location and candidate vendor pair that meets the customer's delivery requirements (e.g., the specified location and time) while minimizing the cost, required travel distance for all parties, time of delivery, etc. The delivery service may use a weighted function to consider multiple criteria. For example, if the customer specifies that he/she wants a fast delivery, the delivery service may weigh the delivery time criteria more heavily. This may result in the selection of a candidate delivery location and candidate vendor pair that has the best delivery time but has an increased delivery cost, and requires the delivery driver to travel a longer distance. In some examples, the delivery service may use a cost function that is separated into two categories, such as time and cost, and these two terms will be weight summed. For each term, it will contain weighted sum of different related items, for example, the time term could be a weighted sum of the expected detour time, expected delivery time, expected customer wait time (if the delivery is a handover), etc., and the cost term may be a weighted sum of the detour cost (in distance and/or fuel/energy), the order cost, the delivery fee, etc. There may be trade-offs between the criteria, and the delivery service may attempt to determine the best candidate delivery location and candidate vendor pair based on trying to meet the customer's requirements while also minimizing one or more of the criteria, such as those noted above.

In some examples, in determining the best candidate delivery location and candidate vendor pair, the delivery service may consider the user profile of the customer. That is, the customer may have a user profile that allows the customer to specify preferred vendors, a preferred delivery location type (e.g., Amazon Locker), preferred criteria used in the optimization/cost function (e.g., preference for minimum delivery fee, minimum detour, etc.), and more.

Referring back to FIG. 3, the diagram 300 illustrates how a target vendor and a target delivery location can be determined based on the target range 340 within the navigational route 312 of the first vehicle 310. As shown, the first vehicle 310 is travelling along the first navigational route 312. When the customer inputs a target delivery time (e.g., “delivery when I arrive at Town”), the delivery service may convert this input of a delivery time range (arrival at town) into a target range 340 along the navigational route 312. The delivery service may then identify a plurality of candidate delivery locations 330A-C based on the target range 340, by identifying each candidate delivery location that is within a distance X of the target range 340. The delivery service may then identify a plurality of candidate vendors 320A-F based on target range 340, by identifying each candidate vendor that is within a distance Y of the target range 340, and/or is within a distance Z of one or more of the candidate delivery locations 330A-C. Given the universe of candidate delivery locations and candidate vendors, each pair of delivery location and vendor may be evaluated (as discussed above), to determine the best pair. The best pair may then be selected as the target delivery location and target vendor.

FIG. 4 illustrates how a target vendor and a target delivery location can be determined based on minimizing the detour required by the customer. As shown in FIG. 4, the customer is travelling in the first vehicle 410 along the first navigational route 412. The delivery service may identify two candidate delivery locations, 430A and 430B. The delivery service may then determine the expected detour required for the first vehicle 410 to travel to each candidate delivery location, labeled as first detour 414A and second detour 414B. The delivery service may then rank candidate delivery location 430A higher than candidate delivery location 430B based on the shorter distance of detour 414A with respect to detour 414B.

In some examples, the order may be associated with a request for immediate delivery, and/or the customer may make an input such as “deliver now” or “deliver as soon as possible.” In this case, the delivery service may set a delivery time frame to begin at the time the order is received and extend to a short time into the future. This may enable the delivery service to attempt to find the closest candidate delivery location and candidate vendor by evaluating candidate delivery locations and candidate vendors beginning with those located nearest to the customer and extending to those farther away. The delivery service may return the first feasible pair, even if the cost is ultimately higher than a different pair that would result in a later delivery.

In some examples, the delivery location and vendor availability and density may change from one area to another (e.g., the candidate vendors near an airport may be sparse while they are more plentiful a short distance away, or the delivery times near a college campus may be relatively high compared to a short distance away). The delivery service may consider the density, positioning, and other aspects of delivery locations and/or vendors in some cases. For example, when a customer travelling from the airport into a nearby city inputs an order, it may be the case that five minutes after the order is input the customer will be in an area of the city with a vendor that can prepare the order faster, has more delivery drivers available, or is otherwise more suited to delivering the order faster or cheaper. In this case, the delivery service may place a hold on the customer's order (and/or may request permission from the customer to do so) until the customer has travelled to the area of the city with better delivery options.

In some examples, the delivery service may differentiate between delivery types, and may take one or more actions depending on whether the customer is requesting a drop off or handover delivery, and/or a secure/unsecure delivery. Each type of delivery may have unique features. For example, if a customer requests an unsecure drop off delivery to occur as soon as possible (e.g., a drone drops off the order in a parking lot), but then the customer is delayed a few hours, the customer may request the drone to go pick up the order and bring it back to the delivery location later, turn around mid-delivery, or upgrade to a secure drop off point (e.g., Amazon locker). Additionally, as noted above, where the delivery vehicle is an autonomous vehicle, the delivery may be a secure handover wherein the customer is provided a one-time use code to access the trunk of the delivery vehicle in which the order is placed.

In some examples, such as on a long road trip, there may be different costs associated with different states. For example, the sales tax in a first state may be higher than the sales tax in a second state. If the timing of the order is not critical (e.g., there is no need for delivery as soon as possible), the delivery service may prioritize vendors in the second state due to the lower sales tax.

In some examples, the delivery service may calculate a difference between the time that the customer is expected to arrive at the target delivery location and the time that the delivery driver is expected to arrive at the target delivery location. The vehicle may then display to the user an expected wait time. This expected wait time may not be important for a system delivering to a fixed addresses (e.g., current delivery techniques), since arrival time is all that the user needs to know. But if the customer is going to wait for an order in a commercial business location, they may want to know how long the wait will be. That way the customer may, for example, slow down to reduce their wait time, get gas, go shopping nearby, or carry out other actions during the expected wait time. The wait time may be updated in real-time based on inputs from customer and delivery driver navigation data. In some examples, a service-level agreement (SLA) may be established between the customer and the delivery service. For example, the delivery vehicle will wait for 5 minutes for free, after which a per minute charge may be applied for waiting. In this case, an indication of whether the customer shall meet the SLA based on the customer's current ETA may also be provided, such as via a visual indication using a color code to display the wait time, or an audio announcement to indicate progress towards meeting the SLA.

In some examples, the delivery service may provide the candidate delivery locations and/or candidate vendors to vehicle for display on a vehicle user interface. The customer may select an option to display all restaurants near location X (wherein location X may be selected by the customer by touching a point along the navigational route), and the vehicle may display all nearby restaurants. In another example, the customer may select a good for delivery (e.g., a phone charger) and may select a location on the map. The vehicle may then display all candidate vendors nearby the selected location that have the phone charger for sale and could fulfill the customer's order.

In some examples, various features described herein may operate in connection with a customer's itinerary instead of the customer's navigational route. For example, a customer may have an itinerary that includes travelling by train from location A to location B, then travelling by car from location B to location C. In this case, the delivery service may function similar to the way described above by using the itinerary in place of the first navigational route. That is, the delivery service may determine candidate delivery locations and candidate vendors based on the expected location of the customer as identified from the itinerary. If the customer inputs an order while travelling along the train from location A to location B, the delivery service may identify candidate delivery locations based on the expected location of the customer upon arrival of the train at location B, and candidate vendors based on the expected arrival time of the customer at location B. The delivery service may also determine that a more optimal delivery location is along the route from location B to location C (or that the optimal delivery location is the ultimate destination of the customer at location C).

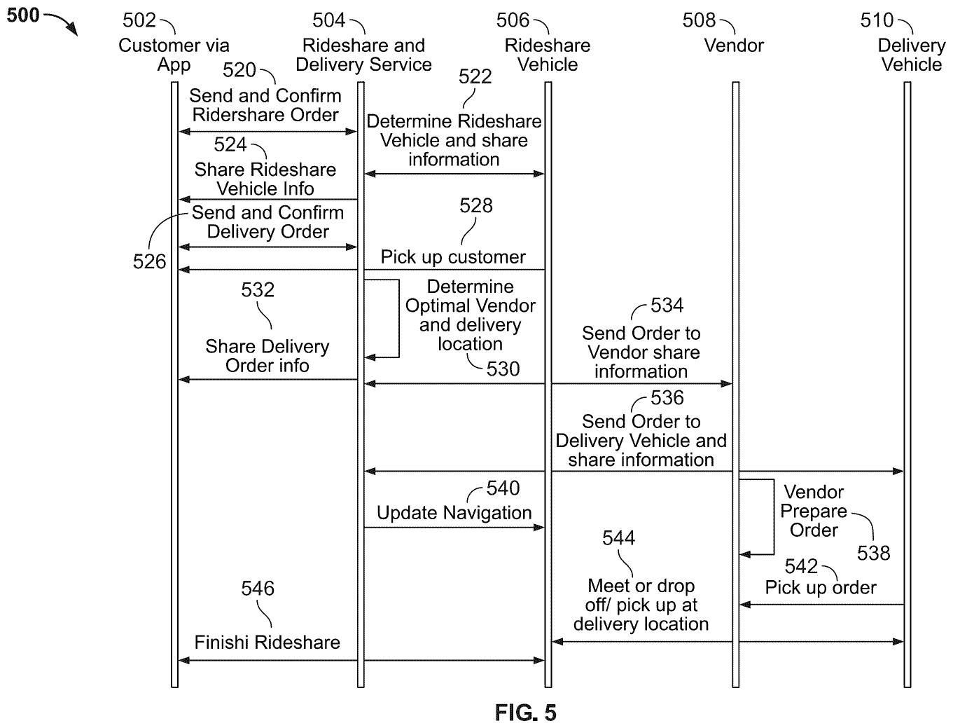

FIG. 5 illustrates a sequence diagram 500 of example steps for delivering an order to a customer in a rideshare context, in accordance with some examples of the disclosure. The embodiments disclosed above include delivery of an order to a customer in a vehicle that the customer controls (e.g., it is the customer's vehicle or the customer controls where the vehicle travels). However, the features and functions described herein also apply in a rideshare context, wherein the customer hires a vehicle to travel to his/her desired destination, and wants to make an order for food or other goods along the way. The disclosure of FIG. 5 may be similar or identical in some respects to the disclosure above with respect to FIGS. 1-4.

In the sequence 500, the customer 502 may be using a single service platform or application that enables the customer to hire a vehicle for transport, as well as to place an order for food or goods for delivery to the customer. Examples of this disclosure enable the delivery service to deliver the order to the rideshare vehicle along the rideshare vehicle's route or in a way that minimizes the rideshare vehicle's detour. In this embodiment, a customer of the rideshare can order food or products to be delivered to their vehicle by initiating an order through the same app, where navigation information is already available with the platform.

In an embodiment, the customer may order food or products while the customer is waiting for the rideshare vehicle to pick him/her up. Once the order is confirmed, the delivery service will identify the optimized delivery location and vendor pair based on the navigation information, time frame, and other factors (e.g., those noted above such as cost and feasibility). In some cases, the optimal delivery location may be the original destination, which may happen if the ride is short. The platform may then assign the order to the selected vendor and notify the customer of the estimated delivery time, while the rideshare driver will be routed to the target delivery location. By integrating the rideshare service, delivery service, and food ordering service into a single platform, the customer can experience a seamless and efficient on-the-go experience, with minimal effort and time required to complete their order.

The sequence 500 of FIG. 5 operates in connection with a customer facing application 502, a rideshare and delivery service application 504, a rideshare vehicle 506, a vendor 508, and a delivery vehicle 510. At step 520, the customer inputs a rideshare order via the rideshare app. The rideshare order is received by the rideshare and delivery service 504. The rideshare order includes a starting location and a destination for the customer.

At step 522, the rideshare and delivery service 504 determines which rideshare vehicle 506 should be dispatched to the customer. This determination may be based on the availability of nearby rideshare vehicles, the cost of the ride, the starting location and destination of the customer, and various other factors. At step 524, the corresponding rideshare vehicle information is shared with the customer. This lets the customer know the identity of the rideshare vehicle that is going to pick him/her up.

At step 526, the customer inputs a delivery order via his/her customer application 502, which is transmitted to the rideshare and delivery service application 504. The order may be for food or other goods to be delivered to the customer. The rideshare and delivery service application 504 confirms that the order has been received by transmitting a confirmation back to the customer application 502.

At step 528, the dispatched rideshare vehicle 506 picks up the customer at the customer's starting location. At step 530, the rideshare and delivery service application 504 determines a target delivery location and a target vendor for delivery of the customer's order. The process of determining the target delivery location and target vendor may be similar or identical to the process described above with respect to FIGS. 1-4.

At step 532, the delivery information (e.g., the target delivery location, the target vendor, and the detour) is shared with the customer via the customer application 502. The customer may have an option to confirm the details, and/or to modify the order. At step 534, the order and other information such as the target delivery location, delivery time, and customer information are sent to the target vendor 508. At step 536, the order and other information is sent to the delivery vehicle 510, if the delivery vehicle 510 is not affiliated with the vendor 508.

At step 538, the target vendor 508 prepares the order. And at step 540, the rideshare and delivery service application 504 sends updated navigational information to the rideshare vehicle 506. The updated navigational information includes a detour that takes the rideshare vehicle 506 along a detour to the target delivery location.

At step 542, the delivery vehicle picks up the order from the vendor, and travels to the target delivery location. At step 544, the delivery driver meets the rideshare vehicle 506 at the target delivery location so the customer can retrieve his/her order. And at step 546, the rideshare vehicle completes the rest of the rideshare by travelling to the customer's original destination. This may include the rideshare vehicle navigating back to the original navigational route.

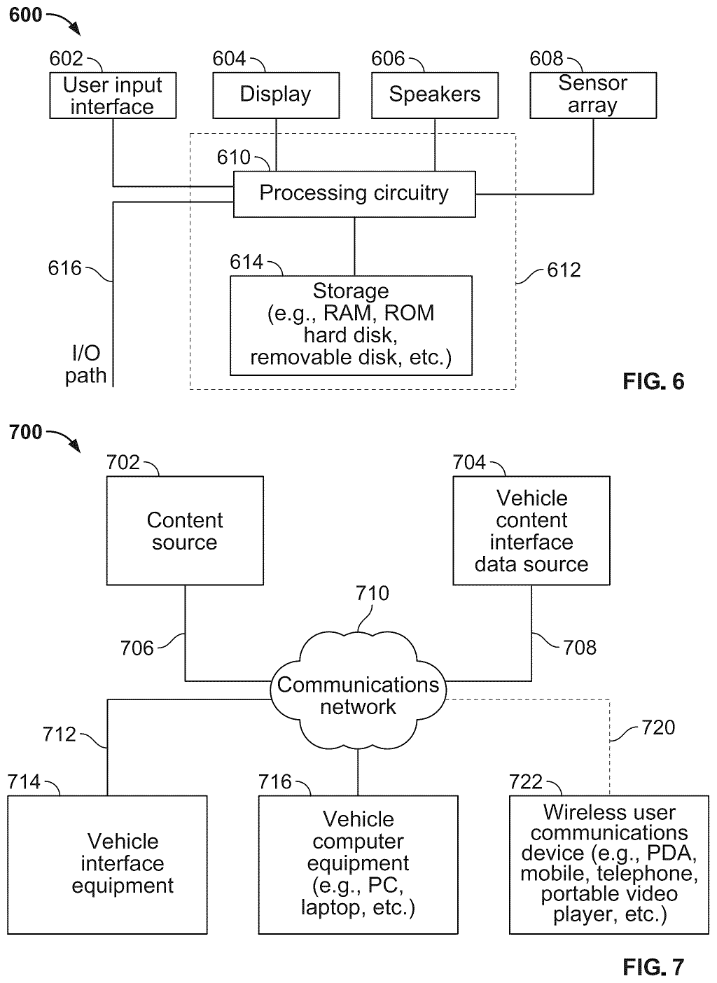

FIG. 6 depicts example devices and related hardware for enabling delivery of an order to a customer on the go, in accordance with some embodiments of the disclosure. FIG. 6 shows a generalized embodiment of illustrative vehicle computing device 600. Vehicle computing device 600 may receive data via input/output (I/O) path 616, and may process input data and output data using input/output circuitry (not shown). I/O path 616 may provide various information described herein (e.g., navigational route instructions, order confirmation, order status, etc.) and data to control circuitry 612, which includes processing circuitry 610 and storage 614. Control circuitry 612 may be used to send and receive commands, requests, and other suitable data using I/O path 616.

Control circuitry 612 may be based on any suitable processing circuitry such as processing circuitry 610. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units. In some embodiments, control circuitry 612 executes instructions for a customer delivery application stored in non-volatile memory (i.e., storage 614). Specifically, control circuitry 612 may be instructed by the customer delivery application to perform one or more functions discussed above and below. For example, the customer delivery application may provide instructions to control circuitry 612 to identify control inputs to the vehicle user interface 602. In some implementations, any action performed by control circuitry 612 may be based on instructions received from the customer delivery application.

In client/server-based embodiments, control circuitry 612 may include communications circuitry suitable for communicating with an application server (e.g., delivery application server, delivery service, or other networks or servers). The instructions for carrying out the above-mentioned functionality may be stored on the application server. Communications circuitry may include a cable modem, an integrated-services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which are described in more detail in connection with FIG. 7). In some embodiments, a sensor array 608 is provided in the vehicle computing device 600. The sensor array 608 may be used for capturing image data, audio data, RF data, and/or any other data. The sensor array 608 may include various sensors, such as one or more cameras, microphones, ultrasonic sensors, RF sensors, and light sensors, for example. The sensor array 608 may also include sensor circuitry which enables the sensors to operate and receive and transmit data to and from the control circuitry 612 and various other components of the vehicle computing device 600. In addition, communications circuitry may include circuitry that enables peer-to-peer communication of user equipment devices, or communication of user equipment devices in locations remote from each other (described in more detail below).

Memory may be an electronic storage device provided as storage 614 that is part of control circuitry 612. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 614 may be used to store various types of content described herein as well as content data and application data that are described above. Nonvolatile memory may also be used (e.g., to launch a boot-up routine and other instructions). Cloud-based storage may be used to supplement storage 614 or instead of storage 614.

In one embodiment, speakers 606 may be provided as integrated with other elements of vehicle computing device 600 or may be stand-alone units. The audio and other content displayed on display 604 may be played through speakers 606. In some embodiments, the audio may be distributed to a receiver (not shown), which processes and outputs the audio via speakers 606.

The customer delivery application may be implemented using any suitable architecture. For example, it may be a stand-alone application wholly implemented on vehicle computing device 600. In such an approach, instructions of the application are stored locally (e.g., in storage 614), and data for use by the application is downloaded on a periodic basis (e.g., from an out-of-band feed, from an Internet resource, or using another suitable approach). Control circuitry 612 may retrieve instructions of the application from storage 614 and process the instructions to carry out any of the functions discussed herein. In some examples, a vehicle may include multiple electronic control units (ECUs) used in conjunction to achieve one or more functions. For example, the sensor array 608 may be fitted with its own processing circuitry (similar to processing circuitry 610) and storage (similar to storage 614) and may communicate via an input/output path (similar to I/O path 616) to another processing circuitry and/or storage. Similarly, display 604 and UI 602 may be connected to another processing circuitry and/or storage. This architecture enables various components to be separated, and may segregate functions to provide failure separation and redundancy.

In some embodiments, the customer delivery application is a client/server-based application. Data for use by a thick or thin client implemented on vehicle computing device 600 is retrieved on-demand by issuing requests to a server remote to the vehicle computing device 600. In one example of a client/server-based application, control circuitry 612 runs a web browser that interprets web pages provided by a remote or edge server. For example, the remote server may store the instructions for the application in a storage device. The remote server may process the stored instructions using circuitry (e.g., control circuitry 612) and carry out one or more of the functions discussed herein. The client device may receive data from the remote server and may also carry out one or more of the functions discussed herein locally on vehicle computing device 600. This way, the processing of the instructions is performed at least partially remotely by the server while other functions are executed locally on vehicle computing device 600. Vehicle computing device 600 may receive inputs from the user or occupant of the vehicle via input interface 602 and transmit those inputs to the remote server for processing. For example, vehicle computing device 600 may transmit, via one or more antenna, communication to the remote server, indicating that a user interface element was selected via input interface 602. The remote server may process instructions in accordance with that input and generate a display of content identifiers associated with the selected user interface element. The generated display is then transmitted to vehicle computing device 600 for presentation to the user or occupant of the vehicle.

In some embodiments, the customer delivery application is downloaded and interpreted or otherwise run by an interpreter or virtual machine (run by control circuitry 612). The customer delivery application may operate in connection with or as a part of an electronic control unit (ECU) of a vehicle. The ECU may be one of many ECUs of the vehicle, wherein each ECU operates to control a particular set of functions of the vehicle, such as engine controls, power train controls, transmission controls, brake controls, etc. The customer delivery application may operate in connection with one or more ECUs of the vehicle in order to carry out the functions described herein.

Vehicle computing device 600 of FIG. 6 can be implemented in system 700 of FIG. 7 as vehicle interface equipment 714, vehicle computer equipment 716, wireless user communications device 722 or any other type of user equipment. For simplicity, these devices may be referred to herein collectively as interface equipment or interface equipment devices and may be substantially similar to the vehicle computing device described above. Interface equipment devices, on which one or more functions of the customer delivery application described herein may be implemented, may function as stand-alone devices or may be part of a network of devices. Various network configurations of devices may be implemented and are discussed in more detail below.

FIG. 7 depicts example systems, servers, and related hardware for enabling on the go delivery of food or other goods to a customer, in accordance with some embodiments of the disclosure. An interface equipment device utilizing at least some of the system features described above in connection with FIG. 6 may not be classified solely as vehicle interface equipment 714, vehicle computer equipment 716, or a wireless user communications device 722. For example, vehicle interface equipment 714 may, like some vehicle computer equipment 716, be Internet-enabled, allowing for access to Internet content, while wireless user computer equipment 722 may, like some vehicle interface equipment 714, include a tuner allowing for access to media programming. The customer delivery application may have the same layout on various types of user equipment or may be tailored to the display capabilities of the interface equipment. For example, on wireless user computer equipment 716, the customer delivery application may be provided as a website accessed by a web browser. In another example, the customer delivery application may be scaled down for wireless user communications devices 722.

The interface equipment devices may be coupled to communications network 710. Communications network 710 may be one or more networks including the Internet, a mobile phone network, mobile voice or data network (e.g., a 4G, 5G or LTE network), cable network, public switched telephone network, or other types of communications network or combinations of communications networks.

System 700 includes delivery service 702 and navigation service 704 coupled to communications network 710. Communications with the delivery service 702 and the navigation service 704 may be exchanged over one or more communications paths but are shown as a single path in FIG. 7 to avoid overcomplicating the drawing. Although communications between services 702 and 704 with interface equipment devices 714, 716, and 722 are shown through communications network 710, in some embodiments, one or both of services 702 and 704 may communicate directly with user equipment devices 714, 716, and 722.

Delivery service 702 may include one or more servers or other computing devices or systems configured to execute the functions described herein, such as identifying candidate delivery locations and candidate vendors, selecting an optimal delivery location/vendor pair, and transmitting various information to one or more other devices or systems. Navigation service 704 may provide navigational instructions or information to one or more devices or systems.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods.

All of the features disclosed in this specification (including any accompanying claims, abstract, and drawings), and/or all of the steps of any method or process so disclosed, may be combined in any combination, except combinations where at least some of such features and/or steps are mutually exclusive.

Each feature disclosed in this specification (including any accompanying claims, abstract, and drawings), may be replaced by alternative features serving the same, equivalent, or similar purpose unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract, and drawings), or to any novel one, or any novel combination, of the steps of any method or process so disclosed. The claims should not be construed to cover merely the foregoing embodiments, but also any embodiments which fall within the scope of the claims.

Throughout the description and claims of this specification, the words “comprise” and “contain” and variations of them mean “including but not limited to”, and they are not intended to (and do not) exclude other moieties, additives, components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

The reader's attention is directed to all papers and documents which are filed concurrently with or previous to this specification in connection with this application and which are open to public inspection with this specification, and the contents of all such papers and documents are incorporated herein by reference.

1. A method comprising:
receiving, from a first device in a vehicle travelling along a first navigational route, a request for delivery of an order to the vehicle within a delivery time frame;
accessing a database of candidate vendors and candidate delivery locations to determine, based on the order and the first navigational route, a plurality of candidate vendors and a plurality of candidate delivery locations;
retrieving, from the database, a target vendor from the plurality of candidate vendors and a target delivery location from the plurality of candidate delivery locations based on optimizing one or more predetermined input criteria;
transmitting the order to the target vendor;
receiving confirmation from the target vendor that the target vendor can fulfill the order within the delivery time frame;
transmitting the target delivery location and the target vendor to the first device;
receiving a confirmation from the first device; and
based on receiving the confirmation from the first device, transmitting an instruction to the target vendor to fulfill the order.

2. The method of claim 1, wherein the one or more predetermined input criteria comprise a fastest order delivery time, and wherein selecting the target vendor from the plurality of candidate vendors and the target delivery location from the plurality of candidate delivery locations based on optimizing the one or more predetermined input criteria comprises:
determining a plurality of pairs of candidate vendors and candidate delivery locations;
determining an estimated delivery time for each pair of candidate vendors and candidate delivery locations; and
selecting as the target vendor and the target delivery location the pair of candidate vendors and candidate delivery locations having the earliest estimated delivery time.

3. The method of claim 1, wherein the one or more predetermining input criteria comprise a shortest detour distance for the vehicle travelling along the first navigational route, and wherein selecting the target delivery location from the plurality of candidate delivery locations based on optimizing the one or more predetermined input criteria comprises:
determining a detour distance for each of the candidate delivery locations, the detour distance comprising a distance the vehicle must travel from the first navigational route to the candidate delivery location; and
selecting as the target delivery location the candidate delivery location having the shortest detour distance.

4. The method of claim 1, wherein the one or more predetermining input criteria comprise a shortest delivery driver wait time, and wherein selecting the target vendor from the plurality of candidate vendors and the target delivery location from the plurality of candidate delivery locations based on optimizing the one or more predetermined input criteria comprises:
determining a plurality of pairs of candidate vendors and candidate delivery locations;
determining an estimated delivery driver wait time for each pair of candidate vendors and candidate delivery locations, wherein the estimated delivery driver wait time comprises a duration of time between an expected arrival of the delivery driver at the candidate delivery location and an expected arrival of the vehicle at the candidate delivery location; and
selecting as the target vendor and the target delivery location the pair of candidate vendors and candidate delivery locations having the shortest delivery driver wait time.

5. The method of claim 1, wherein the target vendor is a first target vendor and the target delivery location is a first target delivery location, the method further comprising:
receiving an indication that the first target vendor cannot fulfill the order within the delivery time frame;
selecting a second target vendor from the plurality of candidate vendors and a second target delivery location from the plurality of candidate delivery locations based on optimizing the one or more predetermined input criteria;
transmitting the order to the second target vendor;
receiving confirmation from the second target vendor that the second target vendor can fulfill the order within the delivery time frame; and
transmitting the second target delivery location to the first device.

6. The method of claim 1, wherein the request for delivery of the order comprises a preferred delivery range associated with the first navigational route, the method further comprising:
determining a target segment of the first navigational route based on the preferred delivery range;
selecting the target vendor from the plurality of candidate vendors based on the target segment of first navigational route; and
selecting the target delivery location from the plurality of candidate delivery locations based on the target segment of first navigational route.

7. The method of claim 1, wherein the request for delivery of the order comprises a preferred delivery time, the method further comprising:
determining a target segment of first navigational route based on the preferred delivery time;
selecting the target vendor from the plurality of candidate vendors based on the target segment of the first navigational route; and
selecting the target delivery location from the plurality of candidate delivery locations based on the target segment of the first navigational route.

8. The method of claim 1, further comprising:
determining the target vendor from the plurality of candidate vendors based on a user profile corresponding to the first device; and
determining the target delivery location from the plurality of candidate vendors based on the user profile corresponding to the first device.

9. The method of claim 1, further comprising:
transmitting, to the first device, a fulfillment progress of the order by the target vendor; and
transmitting, to the first device, a location of a delivery driver delivering the order to the target delivery location.

10. The method of claim 1, further comprising:
determining a second navigational route including a detour from the first navigational route, the detour comprising a first detour segment extending from the first navigational route to the target delivery location, and a second detour segment extending from the target delivery location back to first navigational route; and
transmitting the second navigational route to the first device.

11. A system comprising:
input/output circuitry configured to:
receive, from a first device in a vehicle travelling along a first navigational route, a request for delivery of an order to the vehicle within a delivery time frame; and
control circuitry configured to:
access a database of candidate vendors and candidate delivery locations to determine, based on the order and the first navigational route, a plurality of candidate vendors and a plurality of candidate delivery locations; and
retrieve, from the database, a target vendor from the plurality of candidate vendors and a target delivery location from the plurality of candidate delivery locations based on optimizing one or more predetermined input criteria;
wherein the input/output circuitry is further configured to:
transmit the order to the target vendor;
receive confirmation from the target vendor that the target vendor can fulfill the order within the delivery time frame;
transmit the target delivery location and the target vendor to the first device;
receive a confirmation from the first device; and
based on receiving the confirmation from the first device, transmit an instruction to the target vendor to fulfill the order.

12. The system of claim 11, wherein the one or more predetermined input criteria comprise a fastest order delivery time, and wherein the control circuitry is configured to select the target vendor from the plurality of candidate vendors and the target delivery location from the plurality of candidate delivery locations based on optimizing the one or more predetermined input criteria by:
determining a plurality of pairs of candidate vendors and candidate delivery locations;
determining an estimated delivery time for each pair of candidate vendors and candidate delivery locations; and
selecting as the target vendor and the target delivery location the pair of candidate vendors and candidate delivery locations having the earliest estimated delivery time.

13. The system of claim 11, wherein the one or more predetermining input criteria comprise a shortest detour distance for the vehicle travelling along the first navigational route, and wherein the control circuitry is configured to select the target delivery location from the plurality of candidate delivery locations based on optimizing the one or more predetermined input criteria by:
determining a detour distance for each of the candidate delivery locations, the detour distance comprising a distance the vehicle must travel from the first navigational route to the candidate delivery location; and
selecting as the target delivery location the candidate delivery location having the shortest detour distance.

14. The system of claim 11, wherein the one or more predetermining input criteria comprise a shortest delivery driver wait time, and wherein the control circuitry is configured to select the target vendor from the plurality of candidate vendors and the target delivery location from the plurality of candidate delivery locations based on optimizing the one or more predetermined input criteria by:
determining a plurality of pairs of candidate vendors and candidate delivery locations;
determining an estimated delivery driver wait time for each pair of candidate vendors and candidate delivery locations, wherein the estimated delivery driver wait time comprises a duration of time between an expected arrival of the delivery driver at the candidate delivery location and an expected arrival of the vehicle at the candidate delivery location; and
selecting as the target vendor and the target delivery location the pair of candidate vendors and candidate delivery locations having the shortest delivery driver wait time.

15. The system of claim 11, wherein the target vendor is a first target vendor and the target delivery location is a first target delivery location, and wherein:
the input/output circuitry is further configured to:
receive an indication that the first target vendor cannot fulfill the order within the delivery time frame;
the control circuitry is further configured to:
select a second target vendor from the plurality of candidate vendors and a second target delivery location from the plurality of candidate delivery locations based on optimizing the one or more predetermined input criteria;
and the input/output circuitry is further configured to:
transmit the order to the second target vendor;
receive confirmation from the second target vendor that the second target vendor can fulfill the order within the delivery time frame; and
transmit the second target delivery location to the first device.

16. The system of claim 11, wherein the request for delivery of the order comprises a preferred delivery range associated with the first navigational route, and wherein the control circuitry is further configured to:
determine a target segment of the first navigational route based on the preferred delivery range;
select the target vendor from the plurality of candidate vendors based on the target segment of first navigational route; and
select the target delivery location from the plurality of candidate delivery locations based on the target segment of first navigational route.

17. The system of claim 11, wherein the request for delivery of the order comprises a preferred delivery time, and wherein the control circuitry is further configured to:
determine a target segment of first navigational route based on the preferred delivery time;
select the target vendor from the plurality of candidate vendors based on the target segment of the first navigational route; and
select the target delivery location from the plurality of candidate delivery locations based on the target segment of the first navigational route.

18. The system of claim 11, wherein the control circuity is further configured to:
determine the target vendor from the plurality of candidate vendors based on a user profile corresponding to the first device; and
determine the target delivery location from the plurality of candidate vendors based on the user profile corresponding to the first device.

19. The system of claim 11, wherein the input/output circuitry is further configured to:
transmit, to the first device, a fulfillment progress of the order by the target vendor; and
transmit, to the first device, a location of a delivery driver delivering the order to the target delivery location.

20. The system of claim 11, wherein:
the control circuity is further configured to determine a second navigational route including a detour from the first navigational route, the detour comprising a first detour segment extending from the first navigational route to the target delivery location, and a second detour segment extending from the target delivery location back to first navigational route; and
the input/output circuitry is further configured to transmit the second navigational route to the first device.

21-50. (canceled)
